(19) United States
(12) Patent Application Publication
(10) Pub. No.: US 2024/0363126 A1
(43) Pub. Date: Oct. 31, 2024

(54) AUDIO DATA GENERATION DEVICE, METHOD OF ADVERSARIAL LEARNING FOR AUDIO DATA GENERATION DEVICE, METHOD OF LEARNING FOR AUDIO DATA GENERATION DEVICE, AND SPEECH SYNTHESIS PROCESSING SYSTEM

(71) Applicant: National Institute of Information and Communications Technology, Koganei-shi, Tokyo (JP)

(72) Inventors: Takuma OKAMOTO, Koganei-shi (JP); Tomoki TODA, Nagakute-shi (JP); Hisashi KAWAI, Koganei-shi (JP)

(21) Appl. No.: 18/291,313

(22) PCT Filed: Jun. 21, 2022
(86) PCT No.: PCT/JP2022/024682

§ 371 Date: Jan. 23, 2024

(30) Foreign Application Priority Data
Aug. 23, 2021 (JP) 2021-135430

(51) Int. Cl. G10L 19/00; G10L 13/08; G10L 25/30

(52) U.S. Cl. CPC G10L 19/00; G10L 13/08; G10L 25/30

(57) ABSTRACT

Provided is an audio data generation device that achieves high-quality audio generation processing (for example, speech synthesis processing) at high speed without using a GPU that is capable of high-speed processing. The audio data generation device has a configuration in which a multi-stream generation unit obtains a plurality of stream data; furthermore, introducing a learnable convolution processing unit enables adversarial learning with the high-accurate data discrimination device. The audio data generation device obtained through the adversarial learning can perform high-speed and highly accurate audio data generation processing. Furthermore, the audio data generation device has a simple configuration, thus achieving high-quality audio data generation processing (for example, speech synthesis processing) at high speed without using a GPU that is capable of high-speed processing.

### TECHNICAL FIELD

The present invention relates to audio data synthesis technology (for example, speech synthesis technology).

### BACKGROUND ART

In recent years, speech synthesis technology using neural networks has made progress, and it has become possible to synthesize high-quality speech almost as good as natural speech. In many speech synthesis techniques using neural networks, high-speed calculations with GPU(s) (Graphics Processing Unit(s)) are required to perform speech synthesis processing in real time. However, in order to popularize it as an actual service, it is important to achieve a technology that does not require GPU(s) and can perform high-speed and high-quality speech synthesis using only a CPU (Central Processing Unit).

As techniques for achieving a high-speed and high-quality neural vocoder using a CPU, Multi-band MelGAN (see non-patent document 1) and HiFi-GAN (see non-patent document 2) are known. Both are systems based on an adversarial generative network, and are systems in which a generator and a discriminator are trained simultaneously (adversarial learning neural vocoder). The generator is trained to deceive the discriminator, whereas the discriminator is trained to determine the audio waveform used for training to be real and the audio waveform generated by the generator to be fake; that is, the discriminator is trained to distinguish between real and fake data with high accuracy.

MelGAN (see Non-Patent Document 3), which is the predecessor of Multi-band MelGAN, is a method that uses a generator that converts inputted acoustic features into audio waveforms through several stages of upsampling layers and convolutional layers. In Multi-band MelGAN, in order to speed up conventional MelGAN, a full-band audio signal is divided into multiple sub-band signals (=multiband signals) using sub-band processing based on multi-rate signal processing; the generator simultaneously generates audio waveforms (sub-band signals) of multiple divided bands, performs zero-insertion type up-sampling processing on the generated sub-band signals, and then generates a full-band audio signal from the signal after the zero-insertion type up-sampling processing using pre-calculated synthesis filter(s) (FIR filter(s)). In this case, the discriminator is trained using (1) short-time Fourier transform (STFT) amplitude loss of the multiband signal, (2) STFT amplitude loss of the full-band signal, and (3) discrimination loss that is resulting discrimination loss by the discriminator. As a result, in Multi-band MelGAN, the final up-sampling processing (for example, when using four-divided sub-band signals, up-sampling processing that quadruples the number of data) is simplified to simple zero-insertion processing and FIR filter processing. This allows Multi-band MelGAN to increase speed while maintaining the speech synthesis accuracy of MelGAN.

In contrast, like MelGAN, HiFi-GAN is composed of a generator consisting of several stages of up-sampling layers and convolutional layers, and two types of discriminators. A generator in which the number of channels in the first layer is 512 is called a V1 generator, and a generator in which the number of channels in the first layer is 128 is called a V2 generator.

The V1 generator is capable of high-quality speech synthesis processing, and can generate speech (can synthesize speech) in real time by using a plurality of CPU cores. The V2 generator cannot generate (cannot synthesize speech) as highly accurate speech as the V1 generator; but the V2 generator is capable of performing high-speed speech synthesis with a real-time factor (time required to generate one second of speech) of about 0.1 even with one CPU core.

Introducing two discriminators, which is a multi-period discriminator and a multi-scale discriminator, in HiFi-GAN makes it possible to model the periodic pattern and continuity of the audio waveform as well as the long-term dependence of the audio waveform with high accuracy. This enables HiFi-GAN to perform high-speed processing using a sophisticated network (a model (neural network) that takes into account various features (global features and local features) of the audio waveform) and to perform higher quality speech synthesis processing than Multi-band MelGAN.

### PRIOR ART DOCUMENTS

### Non-Patent Documents

Non-Patent Document 1: G. Yang, S. Yang, K. Liu, P. Fang, W. Chen, and L. Xie, “Multi-band MelGAN: Faster waveform generation for high-quality text-to-speech,” in Proc. SLT, January 2021, pp. 492-498.
Non-Patent Document 2: J. Kong, J. Kim, and J. Bae, “HiFi-GAN: Generative adversarial networks for efficient and high fidelity speech synthesis,” in Proc. NeurIPS, December 2020, pp. 17022-17033.
Non-Patent Document 3: K. Kumar, R. Kumar, T. de Boissiere, L. Gestin, W. Z. Teoh, J. Sotelo, A. de Bre bisson, Y. Bengio, and A. C Courville, “MelGAN: Generative adversarial networks for conditional waveform synthesis,” in Proc. NeurIPS, December 2019, pp. 14910-14921.

### DISCLOSURE OF INVENTION

### Technical Problem

Although HiFi-GAN is capable of generating (synthesizing) high-quality speech at high speed, there is a trade-off relationship between sound quality and generation speed (speech synthesis processing speed). In other words, with the V1 generator (V1 model) of HiFi-GAN, the quality of generated speech is high, but the generation speed (speech synthesis processing speed) is not so fast. Conversely, with the V2 generator (V2 model), the generation speed (speech synthesis processing speed) is as fast as Multi-band MelGAN, but the quality of the generated speech (sound quality) is not so high, and it is on the same level as Multi-band MelGAN.

As a simple solution for achieving high-quality speech synthesis processing at high speed, a method of introducing a multiband generation algorithm into HiFi-GAN may be considered, so we investigated this method in preliminary experiments. However, it has been found that the method of introducing the multiband generation algorithm into HiFi-GAN has a problem in that the loss of the generator cannot be lowered and thus learning cannot be performed well. In the method of introducing the multiband generation algorithm into HiFi-GAN, the reason why the loss of the generator cannot be lowered and learning cannot be performed well is because the two discriminators of HiFi-GAN have very high discriminating ability, and thus the two discriminators can determine that fake data is identified as a fake once the constraint of multiband has been introduced. As a result of investigation, it has been found that even if pre-training using only STFT amplitude loss, which is used in Multi-band MelGAN, is used, successful learning still cannot be achieved.

To solve the above problems, it is an object of the present invention to provide an audio data generation device that achieves high-quality audio generation processing (for example, speech synthesis processing) at high speed without using a GPU that is capable of high-speed processing.

### Solution to Problem

To solve the above problems, a first aspect of the present invention provides an audio data generation device including a multi-stream generation unit, an up-sampling unit, and a convolution processing unit.

The multi-stream generation unit includes a learnable function unit and obtains multiple stream data from mel spectrogram data.

The up-sampling unit obtains up-sampled multi-stream data by performing up-sampling processing on each of the plurality of stream data.

The convolution processing unit, which is capable of learning parameters for determining convolution processing, obtains audio waveform data by performing convolution processing on the up-sampled multi-stream data.

The audio data generation device has a configuration in which a multi-stream generation unit obtains a plurality of stream data (for example, four pieces of data-driven decomposition data (audio waveform data)); furthermore, introducing a learnable convolution processing unit enables adversarial learning with a highly accurate audio data discrimination device. The audio data generation device obtained through the adversarial learning can perform high-speed and highly accurate audio data generation processing. Furthermore, the audio data generation device, which has a simple configuration, makes it is possible to perform high-quality audio data generation processing (for example, speech synthesis processing) with high speed without using a GPU that is capable of high-speed processing.

A second aspect of the present invention provides the audio data generation device of the first aspect of the present invention in which the convolution processing unit performs convolution processing without bias.

This allows the configuration of the convolution processing unit in the audio data generation device to be similar to the configuration of the FIR filter(s).

A third aspect of the present invention provides the audio data generation device of the first or second aspect of the present invention in which the up-sampling unit performs zero-insertion type up-sampling processing.

This allows the audio data generation device to perform up-sampling processing with a simple configuration, thereby enabling high-speed processing.

A fourth aspect of the present invention provides an adversarial learning method to be performed using the audio data generation device according to any one of the first to third aspects of the present invention and an audio data discrimination device including:
a global feature discriminator that includes a learnable function unit and discriminates authenticity of audio data based on global features of audio data; and
a detailed feature discriminator that includes a learnable function unit and discriminates authenticity of audio data based on detailed features of audio data,

The adversarial learning method for the audio data generation device includes a discrimination step, a loss evaluation step, a generator parameter update step, and a discriminator parameter update step.

The discrimination step inputs audio data generated by the audio data generation device or correct data of audio data into the audio data discrimination device, and causes the audio data discrimination device to discriminate authenticity of the input data.

The loss evaluation step obtains loss evaluation data using a loss function based on resultant data of the discrimination step.

The generator parameter updating step updates parameters of the convolution processing unit of the audio data generation device and parameters of the learnable function unit of the multi-stream generation unit based on the loss evaluation data obtained in the loss evaluation step.

Based on the loss evaluation data obtained in the loss evaluation step, the discriminator parameter updating step updates the parameters of the learnable function unit of the global feature discriminator of the audio data discrimination, and updates parameters of the learnable function unit of the discriminator of the detailed feature discriminator of the audio data discrimination device.

In the adversarial learning method for the audio data generation device, adversarial learning is performed using the audio data discrimination device that includes the global feature discriminator and the detailed feature discriminator and has strong discrimination ability; thus the trained audio data generation device allows for generating highly accurate audio data. Further, in the adversarial learning method for the audio data generation device, the audio data generation device includes the multi-stream generation unit that generates a plurality of streams, and the convolution processing unit that can learn on data after up-sampling; thus, even when adversarial learning is performed using the audio data discrimination device with strong discrimination ability, learning can proceed efficiently and convergence can be achieved reliably.

A fifth aspect of the present invention provides a learning method for the audio data generation device according to any one of the first to third aspects of the present invention; the learning method includes an STFT loss evaluation step and a generator parameter updating step.

The STFT loss evaluation step evaluates the loss between audio data corresponding to the mel spectrogram inputted into the audio data generation device and the generated audio data generated from the input mel spectrogram in the audio data generation device using a short-term Fourier transform loss function.

The generator parameter updating step updates parameters of the convolution processing unit of the audio data generation device and parameters of the learnable function unit of the multi-stream generation unit based on the evaluation result in the STFT loss evaluation step.

Thus, the learning method for the audio data generation device allows for performing the learning processing of the audio data generation device with the evaluation value (loss value) using the short-term Fourier transform loss function. Further, for example, the learning processing by the learning method of the audio data generation device may be employed as pre-training for adversarial learning using the audio data discrimination device of the audio data generation device.

A sixth aspect of the present invention provides a speech synthesis processing system including an audio processing device that outputs mel spectrum data from text data, and an audio data generation device according to any one of the first to third aspects of the present inventions.

The speech synthesis processing system uses the audio data generation device that can generate speech waveform data from mel spectrogram using a CPU without using a high-speed GPU, thus allowing for performing high-speed, highly accurate speech synthesis processing.

### Advantageous Effects

The present invention provides an audio data generation device that achieves high-quality audio generation processing (for example, speech synthesis processing) at high speed without using a GPU that is capable of high-speed processing.

### BRIEF DESCRIPTION OF THE DRAWINGS

FIG. 1 is a schematic configuration diagram of an audio data processing system 1000 according to a first embodiment.

FIG. 2 is a schematic configuration diagram of a multi-stream generation unit 1 of an audio data generation device 100 of the audio data processing system 1000 according to the first embodiment.

FIG. 3 is a schematic configuration diagram of a first MRF processing unit 122 of the multi-stream generation unit 1 of the audio data generation device 100 according to the first embodiment.

FIG. 4 is a schematic configuration diagram of the components (ResBlock[n]) of a residual block group 1221 of the first MRF processing unit 122 according to the first embodiment.

FIG. 5 is a schematic configuration diagram of a global feature discrimination unit DD1 of an audio data discrimination device Dev_D according to the first embodiment.

FIG. 6 is a schematic configuration diagram of a detailed feature discrimination unit DD2 of the audio data discrimination device Dev_D according to the first embodiment.

FIG. 7 is a flowchart of learning processing performed by the audio data processing system 1000.

FIG. 8 is a diagram showing a CPU bus configuration.

### DESCRIPTION OF THE PREFERRED EMBODIMENTS

### First Embodiment

A first embodiment will be described below with reference to the drawings.

### 1.1: Configuration of Audio Data Processing System

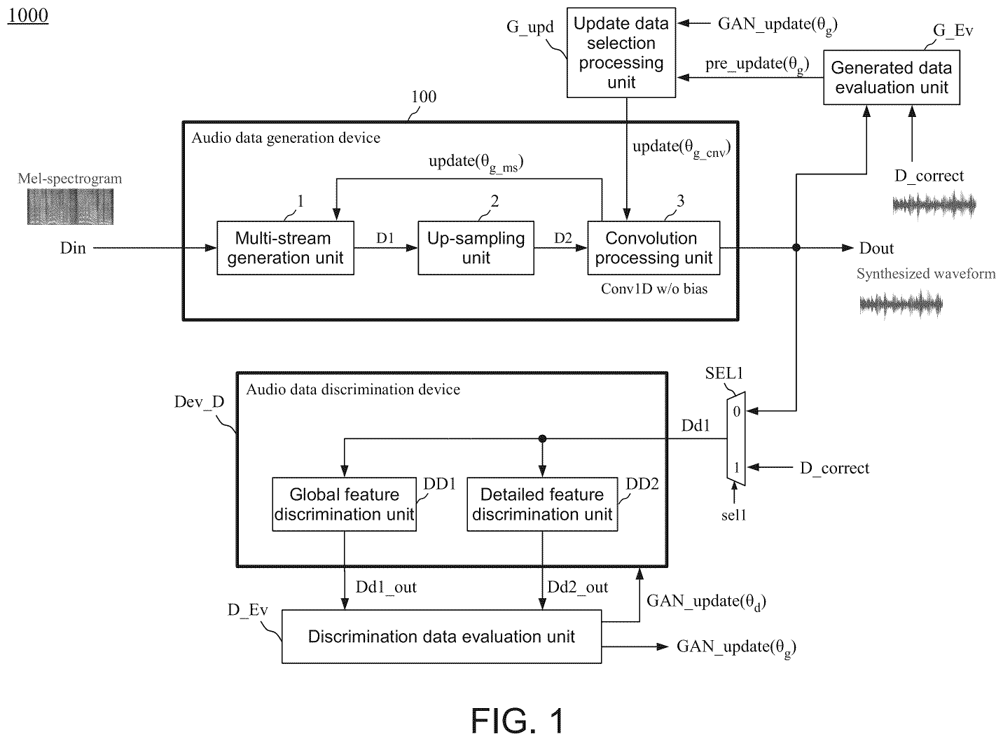

FIG. 1 is a schematic configuration diagram of an audio data processing system 1000 according to a first embodiment.

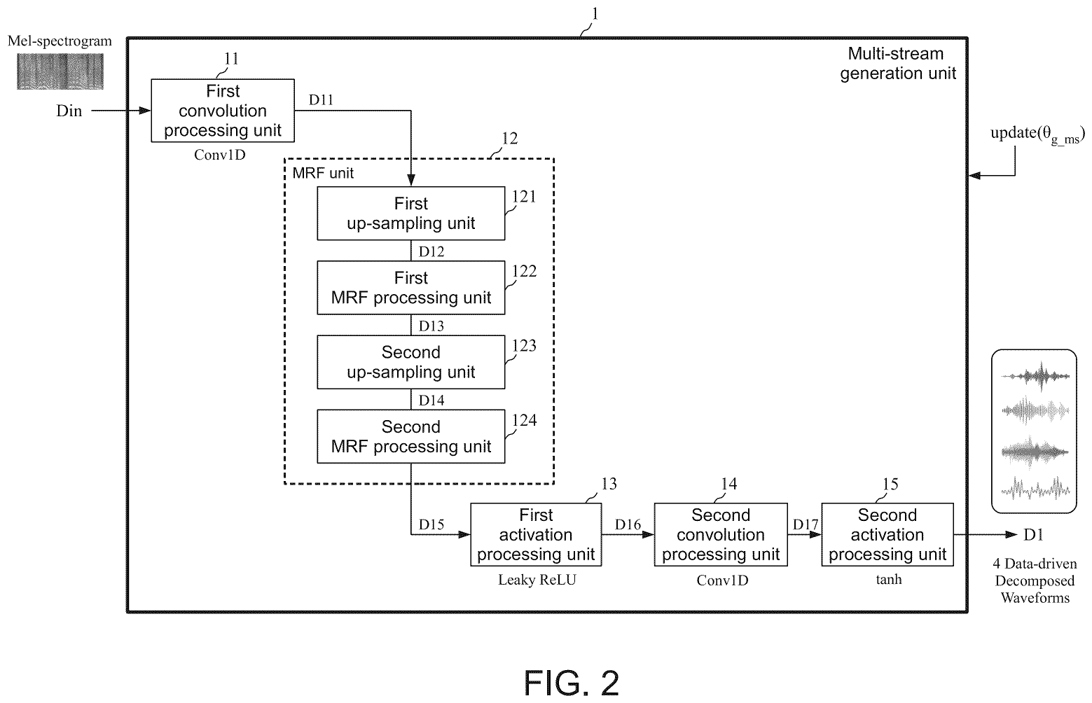

FIG. 2 is a schematic configuration diagram of a multi-stream generation unit 1 of an audio data generation device 100 of the audio data processing system 1000 according to the first embodiment.

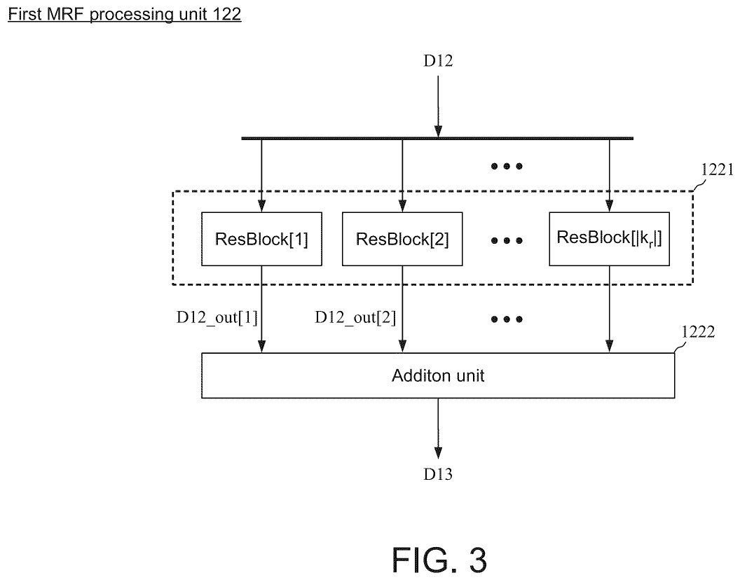

FIG. 3 is a schematic configuration diagram of a first MRF processing unit 122 of the multi-stream generation unit 1 of the audio data generation device 100 according to the first embodiment.

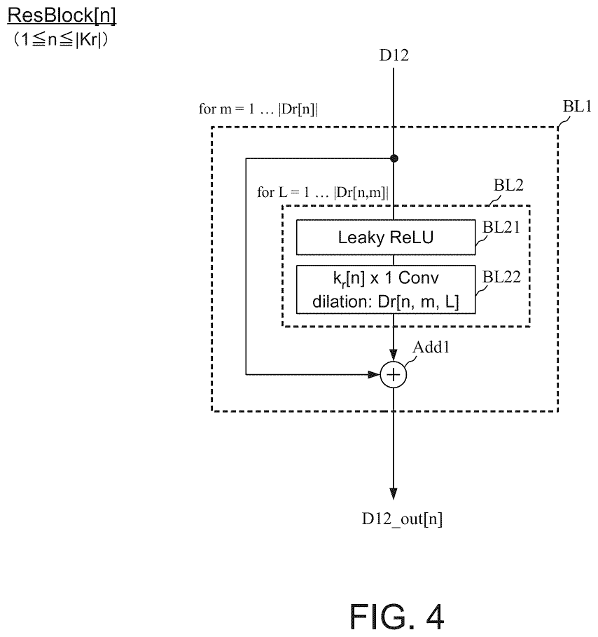

FIG. 4 is a schematic configuration diagram of the components (ResBlock[n]) of a residual block group 1221 of the first MRF processing unit 122 according to the first embodiment.

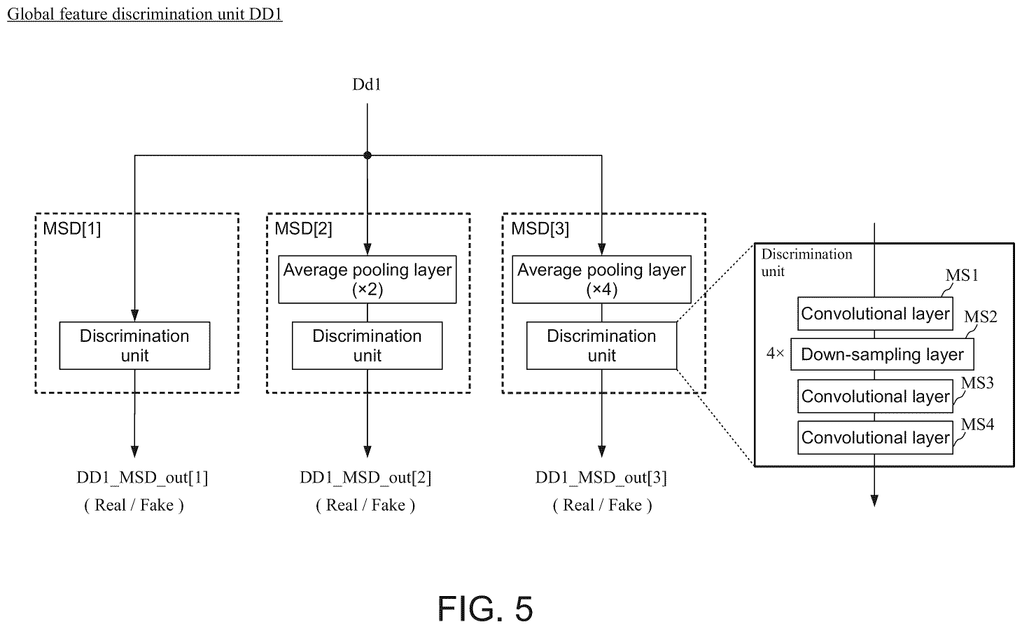

FIG. 5 is a schematic configuration diagram of a global feature discrimination unit DD1 of an audio data discrimination device Dev_D according to the first embodiment.

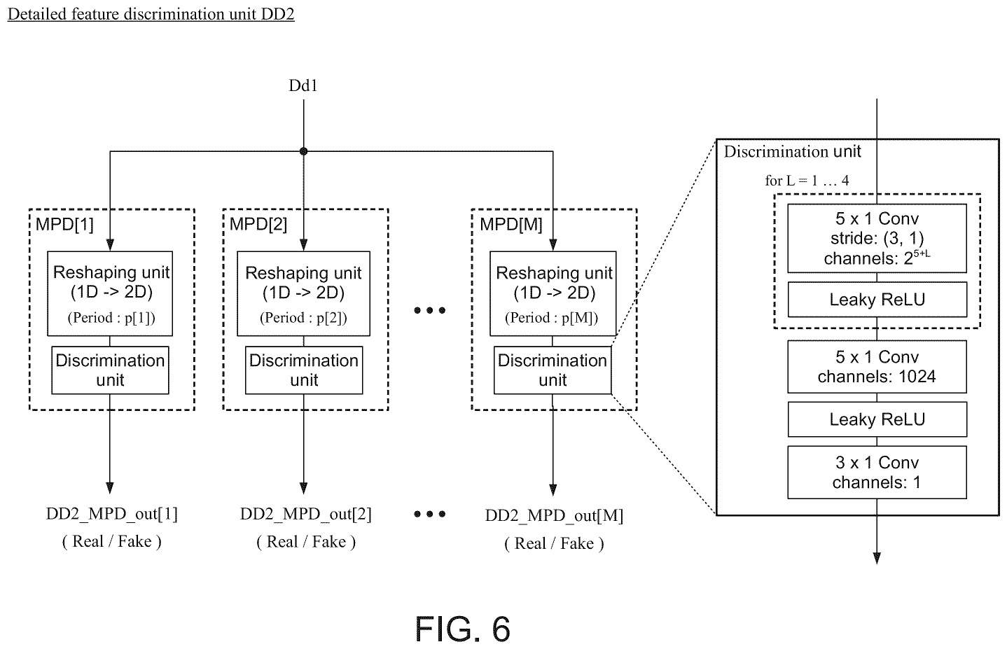

FIG. 6 is a schematic configuration diagram of the detailed feature discrimination unit DD2 of the audio data discrimination device Dev_D according to the first embodiment.

As shown in FIG. 1, the audio data processing system 1000 includes an audio data generation device 100, a generated data evaluation unit G_Ev, a selector SEL1, an audio data discrimination device Dev_D, a discrimination data evaluation unit D_Ev, and an update data selection processing unit G_upd.

### 1.1.1: Audio Data Generation Device

The audio data generation device 100 includes a multi-stream generation unit 1, an up-sampling unit 2, and a convolution processing unit 3, as shown in FIG. 1. The audio data generation device 100 receives data Din that is mel spectrogram data, performs audio data generation processing on the data Din, and transmits (obtains) audio waveform data Dout.

As shown in FIG. 2, the multi-stream generation unit 1 includes a first convolution processing unit 11, an MRF unit 12, a first activation processing unit 13, a second convolution processing unit 14, and a second activation processing unit 15.

The first convolution processing unit 11 receives data Din, which is mel spectrogram data, and performs one-dimensional convolution processing (Conv1D processing) on the data Din (data Din (one-dimensional convolution processing that is performed regarding mel spectrum data as two-dimensional data)). The first convolution processing unit 11 transmits the data after the one-dimensional convolution processing (Conv1D processing) to the MRF unit as data D11. Note that the one-dimensional convolution processing (Conv1D process) performed by the first convolution processing unit 11 is performed with a kernel size set to “7” (equivalent to 7 samples) and the number of channels set to “512”, for example.

As shown in FIG. 2, the MRF unit 12 includes a first up-sampling unit 121, a first MRF processing unit 122, a second up-sampling unit 123, and a second MRF processing unit 124.

The first up-sampling unit 121 receives the data D11 transmitted from the first convolution processing unit 11, and performs up-sampling processing on the data D11. The first up-sampling unit 121 transmits the data after the up-sampling processing to the first MRF processing unit 122 as data D12. Note that the up-sampling processing performed by the first up-sampling unit 121 is performed, for example, by increasing the number of samples of input data by eight times (×8) and by setting the number of channels to “256”. For example, the following method may be used for the up-sampling processing.

### (1) Up-Sampling Processing Using Subpixel Convolution Processing

For example, one-dimensional convolution processing (Conv1D processing) is performed with the kernel size set to “3”, and then reshape processing is performed to realize up-sampling processing. In addition, the number of channels for one-dimensional convolution processing (Conv1D processing), the length of reshape processing, and the number of channels may be adjusted so that the number of samples of input data is increased by eight times (×8) and the number of channels becomes “256”.

### (2) Up-Sampling Processing Using Transposed Convolution Processing

For example, up-sampling processing is realized by performing transposed convolution processing with a stride of n/2 using an n×1 kernel. Note that the kernel size of the transposed convolution processing and the number of channels may be adjusted so that the number of samples of input data is increased by eight times (×8) and the number of channels becomes “256”.

### (3) Sampling Processing Using Interpolation and One-Dimensional Convolution Processing (Conv1D Processing)

For example, up-sampling processing is realized by performing interpolation processing (for example, processing of interpolating adjacent samples) and further performing one-dimensional convolution processing (Conv1D processing). Note that the number of samples to be interpolated in the interpolation processing, a kernel size for the one-dimensional convolution processing (Conv1D process), and the number of channels may be adjusted so that the number of samples of the input data is 8 times (×8) and the number of channels becomes “256”.

The first MRF processing unit 122 includes, for example, a residual block group 1221 and an addition unit 1222, as shown in FIG. 3.

As shown in FIG. 3, the residual block group 1221 includes a plurality of residual blocks ResBlock[1] to ResBlock[|kᵣ|], each of which receives the data D12 outputted from the first up-sampling unit 121.

As shown in FIG. 4, the residual block ResBlock[n] (1≤n≤|kᵣ|) (|kᵣ| represents the number of elements (the number of arrays) included in the array kᵣ) have a configuration in which a plurality of blocks BL1 (|Dr[n]| blocks BL1) are connected in series.

The block BL1 includes a plurality of blocks BL2 (|Dr[n,m]| blocks BL2) connected in series, and an adder Add1 that adds the data D12 and the output of the final stage block BL2.

As shown in FIG. 4, the block BL2 includes an activation processing unit BL21 and a convolution processing unit BL22.

The activation processing unit BL21 is a function unit that performs activation processing using the Leaky ReLU function (the function unit indicated by “Leaky ReLU” in FIG. 4).

The convolution processing unit BL2 is a function unit (indicated by “kᵣ[n]×1 Conv” in FIG. 4) that performs convolution processing using a kᵣ[n]×1 kernel. Note that the convolution processing unit BL2 performs convolution processing on the output data from the activation processing unit BL21 in the previous stage using a kernel of kᵣ[n]×1 with dilation set as Dr[n, m, L].

For example, a case where kᵣ and Dr are set as follows will be explained.

Kᵣ=[k1,k2,k3]

Dr=[[[a1,a2],[b1,b2],[c1,c2]],

[[d1,d2],[e1,e2],[f1,f2]]]

In the above case, |kᵣ|=3 and |Dr[n,m]|=3 are satisfied.

In the above case, for Dr[n,m,L], Dr[1,1,1]=a1, Dr[1,1,2]=a2, Dr[1,1,2]=b1, Dr[1,2,2]=b2, . . . , Dr[2,3,1]=f1, Dr[2,3,2]=f2 are satisfied.

With the above configuration, the residual block ResBlock[n]transmits the processed result data to the addition unit 1222 as data D12_out[n].

The addition unit 1222 adds the output data D12_out[1] to D12_out[|kᵣ|] from each block of the residual block group 1221, and then transmits the addition result data to the second up-sampling unit 123 as data D13.

The second up-sampling unit 123 receives the data D13 transmitted from the first MRF processing unit 122, and performs up-sampling processing on the data D13. The second up-sampling unit 123 transmits the data after the up-sampling processing to the second MRF processing unit 124 as data D14. Note that the up-sampling processing performed by the second up-sampling unit 123 is performed by increasing the number of samples of input data by eight times (×8) and setting the number of channels to “128”, for example. As for the up-sampling processing method, like the first upsampling unit, one of the following may be employed.
(1) Up-sampling processing using subpixel convolution processing
(2) Up-sampling processing using transposed convolution processing
(3) Sampling processing using interpolation and one-dimensional convolution processing (Conv1D processing)

The second MRF processing unit 124 has the same configuration as the first MRF processing unit, and performs processing on the data D14 transmitted from the second up-sampling unit 123 in the same manner as the first MRF processing unit (The set values of kᵣ and Dr may be different from the set values of the first MRF processing unit). The second MRF processing unit 124 then transmits the data after processing by the second MRF processing unit 124 to the first activation processing unit 13 as data D15.

The first activation processing unit 13 receives the data D15 transmitted from the second MRF processing unit 124 of the MRF unit 12, and performs activation processing on the data D15 using a Leaky ReLU function. The first activation processing unit 13 then transmits the data after the activation processing to the second convolution processing unit 14 as data D16.

The second convolution processing unit 14 receives the data D16 transmitted from the first activation processing unit 13, and performs one-dimensional convolution processing (Conv1D processing) on the data D16. The second convolution processing unit 14 then transmits the data after the one-dimensional convolution processing (Conv1D processing) to the second activation processing unit 15 as data D17. Note that the one-dimensional convolution processing (Conv1D processing) performed by the second convolution processing unit 14 is performed with the kernel size set to “7” (equivalent to 7 samples) and the number of channels set to “4”, for example.

The second activation processing unit 15 receives the data D17 transmitted from the second convolution processing unit 14, and performs activation processing on the data D17 using the tan h function. The second activation processing unit 15 then transmits the data after the activation processing to the up-sampling unit 2 as data D1. Note that when the number of channels of the second convolution processing unit 14 is “4”, the data D1 is audio waveform data (four pieces of audio waveform data) obtained by performing the activation processing by the second activation processing unit 15 on each of the four pieces of audio waveform data transmitted from the second convolution processing unit 14; that is, the data D1 is multi-stream data (a plurality of pieces of audio waveform data).

Note that during learning, the multi-stream generation unit 1 receives parameter update data update(θ_{g_ms}) transmitted from the convolution processing unit 3 (parameter update data for parameters θ_{g_ms} of the multi-stream generation unit 1 (the second convolution unit 14, the MRF unit 12, and the first convolution processing unit 11)), and performs parameter update processing (parameter update processing to reduce loss) of parameters θ_{g_cnv} of the multi-stream generation unit 1 (the second convolution unit 14, the MRF unit 12, the first convolution processing unit 11) based on the data update(θ_{g_ms}).

Further, the configuration of the MRF unit of the multi-stream generation unit 1 (for example, the configuration of the first MRF processing unit 122, the second MRF processing unit 124 or the like) is provided by using, for example, the technology disclosed in Non-Patent Document 2.

The up-sampling unit 2 receives data D1 (multi-stream data (a plurality of pieces of audio waveform data)) transmitted from the second activation processing unit 15 of the multi-stream generation unit 1, and performs, for example, zero-insertion type up-sampling processing on the data D1. In the up-sampling process, the data after the up-sampling processing is then transmitted to the convolution processing unit 3 as data D2 (multi-stream data (a plurality of pieces of audio waveform data) after the up-sampling processing).

The convolution processing unit 3 receives the data D2 transmitted from the up-sampling unit 2, and performs one-dimensional convolution processing (Conv1D processing (without bias)) on the data D2. The convolution processing unit 3 then transmits the data after the one-dimensional convolution processing (Conv1D processing) to the generated data evaluation unit and the selector SEL1 as data Dout.

Note that the one-dimensional convolution processing (Conv1D processing (without bias)) performed by the convolution processing unit 3 is performed with the kernel size set to “63” (equivalent to 63 samples) and the number of channels set to “1”, for example. In other words, the data D2 (multi-stream data (for example, four pieces of audio waveform data)) inputted into the convolution processing unit 3 is synthesized by one-dimensional convolution processing (Conv1D processing (without bias)) by the convolution processing unit 3, thereby obtaining (generating) one piece of audio waveform data.

Note that during learning, the convolution processing unit 3 receives the data update(θ_{g_cnv}) (parameter update data of the parameters θ_{g_cnv} of the convolutional layer of the convolution processing unit 3) transmitted from the update data selection processing unit G_upd, and performs update processing of the parameters θ_{g_cnv} of convolutional layers of the convolution processing unit 3 (parameter update processing to reduce loss) based on the data update(θ_{g_cnv}).

After performing the above update processing, the convolution processing unit 3 also generates parameter update data update(θg_ms) for updating the parameters of the multi-stream generation unit 1 (the second convolution unit 14, the MRF unit 12, and the first convolution processing unit 11), and transmits the parameter update data update(θg_ms) to the multi-stream generation unit 1.

### 1.1.2: Generated Data Evaluation Unit G_Ev

The generated data evaluation unit G_Ev evaluates the data Dout transmitted from the audio data generation device 100 and audio waveform data D_correct (correct data) corresponding to the input data Din (mel spectrogram data) of the audio data generation device 100 used to generate the data Dout. Using an evaluation function (loss function) that evaluates STFT loss (STFT: short-time Fourier transform) for the data Dout and the data D_correct (correct data), the generated data evaluation unit G_Ev evaluates the error (loss) between the two. The generated data evaluation unit G_Ev then generates parameter update data pre_update(θ_{g}), which is data for updating the parameters θ_{g} of the learnable function unit(s) (learnable convolutional layers or the like) of the audio data generation device 100, based on the output (result) of the STFT loss evaluation function, and then transmits the parameter update data pre_update(θ_{g}) to the update data selection processing unit G_upd.

### 1.1.3: Selector SEL1

The selector SEL1 Is a selector with two inputs and one output, and receives data Dout transmitted from the audio data generation device 100 (the data Dout (synthesized data (fake data)) generated by the audio data generation device 100) and real data D_correct (for example, audio waveform data D_correct (correct data) corresponding to the input data Din (mel spectrogram data) of the audio data generation device 100 used to generate the data Dout).

For example, the selector SEL1 selects the data Dout or the data D_correct in accordance with a selection signal sell transmitted from a control unit (not shown), and inputs the selected data into the audio data discrimination device Dev_D.

### 1.1.4: Audio Data Discrimination Device Dev_D

The audio data discrimination device Dev_D is a discriminator used for adversarial learning, and is a discriminator when the audio data generation device 100 is used as a generator in adversarial learning. As shown in FIG. 1, the audio data discrimination device Dev_D includes a global feature discrimination unit DD1 and a detailed feature discrimination unit DD2.

As shown in FIG. 5, the global feature discrimination unit DD1 includes a plurality of discriminators MSD[k] (in FIG. 5, discriminators MSD[1] to MSD[3]) (MSD: Multi-scale Descriptor). For convenience of explanation, a case where there are three discriminators MSD[k] will be explained below, but the number of discriminators MSD[k] should not be limited to three and may be any other number.

The first discriminator MSD[1] inputs the data Dd1 as it is into the discrimination unit, as shown in FIG. 5. For example, as shown in FIG. 5, the discrimination unit includes a convolutional layer MS1, a down-sampling layer MS2 (for example, it has a configuration in which four down-sampling layers are connected in series), a convolutional layer MS3, and a convolutional layer MS4. Resultant data DD1_MSD_out[1] indicating the authenticity of the input data Dd1 (indicating whether the input data Dd1 is real data (Real) or fake data generated by the audio generation processing (Fake)) is outputted from the convolutional layer MS4 at the final stage.

The second discriminator MSD[2] includes an average pooling layer and a discrimination unit, as shown in FIG. 5.

The average pooling layer performs average pooling processing in which the average value of two adjacent (adjacent in time series) samples of Dd1 is used as output data.

The output of the average pooling layer is then inputted into the discrimination unit of the second discriminator MSD[2].

The discrimination unit of the second discriminator MSD[2] has the same configuration as the discrimination unit of the first discriminator MSD[1]. The discrimination unit of the second discriminator MSD[2] outputs resultant data DD1_MSD_out[2] indicating the authenticity of the input data Dd1 (indicating whether the data Dd1 is real data (Real) or fake data generated by audio generation processing (Fake)).

The third discriminator MSD[3] includes an average pooling layer and a discrimination unit, as shown in FIG. 5.

The average pooling layer performs average pooling processing in which the average value of four adjacent (adjacent in time series) samples of Dd1 is used as output data.

The output of the average pooling layer is then inputted into the discrimination unit of the third discriminator MSD[3].

The discrimination unit of the third discriminator MSD[3] has the same configuration as the discrimination unit of the first discriminator MSD[1]. The discrimination unit of the third discriminator MSD[3] outputs resultant data DD1_MSD_out[3] indicating the authenticity of the input data Dd1 (indicating whether the input data Dd1 is true (Real) or fake data generated by audio generation processing (Fake)).

The output data (data DD1_MSD_out[1] to DD1_MSD_out[3]) of the plurality of discriminators MSD[k] of the global feature discrimination unit DD1 is outputted to the discrimination data evaluation unit D_Ev.

Note that data that is a collection of output data (data DD1_MSD_out[1] to DD1_MSD_out[3]) of the plurality of discriminators MSD[k] of the global feature discrimination unit DD1 is expressed as data Dd1_out.

As shown in FIG. 6, the detailed feature discrimination unit DD2 includes a plurality of discriminators MPD[k] (in FIG. 6, discriminators MPD[1] to MPD[M]) (MPD: Multi-period Descriptor) (M is a natural numbers).

The k-th discriminator MPD[k] (k is a natural number satisfying 1≤k≤M) includes a reshaping unit and a discrimination unit, as shown in FIG. 5.

The reshaping unit converts the data Dd1 (one-dimensional data) into two-dimensional data for each period p[k] (every p[k] samples) (p[k]×ceil(T/p[k]) two-dimensional data (ceil( ) is a ceiling function) where the number of samples of the data Dd1 is T). The reshaping unit outputs the two-dimensional data after the processing to the discrimination unit.

The discrimination unit performs convolution processing on the two-dimensional data outputted from the reshaping unit, and obtains resultant data DD2_MPD_out[k] indicating the authenticity of the input data Dd1 (indicating whether the data Dd1 is real data (Real) or fake data generated by the audio generation processing (Fake)).

As shown in FIG. 6, the discrimination unit has a configuration in which four blocks, each of which includes a 5×1 convolutional layer (stride: (3, 1), the number of channels: 2\hat{ }(5+L)) and an activation processing unit (function unit that performs activation processing using the Leaky ReLU function), are connected in series and further a 5×1 convolutional layer (the number of channels: 1024), an activation processing unit (function unit that performs activation processing using Leaky ReLU function), and a 3×1 convolutional layer (the number of channels: 1) are included at the subsequent stage.

The discrimination unit performs convolution processing and activation processing with the above configuration to obtain resultant data DD2_MPD_out[k] indicating the authenticity of the input data Dd1 (indicating whether the data Dd1 is real data (Real) or fake data generated by the audio generation processing (Fake)).

The output data (data DD2_MPD_out[1] to DD2_MPD_out[M]) of the plurality of discriminator s MPD[k] of the detailed feature discrimination unit DD2 is outputted to the discrimination data evaluation unit D_Ev.

Note that data that is a collection of output data (data DD2_MPD_out[1] to DD2_MPD_out[M]) of the plurality of discriminators MPD[k] of the detailed feature discrimination unit DD2 is expressed as data Dd2_out.

Further, the global feature discrimination unit DD1 (discriminators MSD[k]) and the detailed feature discrimination unit DD2 (discriminators MPD[k]) may be provided by using techniques disclosed in, for example, Non-Patent Document 2 and Non-Patent Document 3.

Also, during learning, the audio data discrimination device Dev_D receives data GAN_update(θ_{d}) outputted from the discrimination data evaluation unit D_Ev (parameter update data of the parameters Od of the learnable unit(s) (convolutional layers, or the like) of the audio data discrimination device Dev_D), and performs updating processing of the parameters θ_{g_d} of the learnable unit(s) (convolutional layers or the like) of the audio data discrimination device Dev_D (parameter update processing to reduce loss) based on the data update(Od).

### 1.1.5: Discrimination Data Evaluation Unit D_Ev

The discrimination data evaluation unit D_Ev receives the data Dd1_out and Dd2_out transmitted from the audio data discrimination device Dev_D, and performs loss evaluation in adversarial learning using a loss function for the generator (corresponding to the audio data generation device 100) and a loss function for the discriminator (corresponding to the audio data discrimination device).

Based on the result of the above-described loss evaluation, the discrimination data evaluation unit D_Ev generates parameter update data GAN_update(θ_{g}) that is data for updating the parameters θ_{g} of the learnable function unit(s) (learnable convolutional layers or the like) of the audio data generation device 100, and then transmits the parameter update data GAN_update(θ_{g}) to the update data selection processing unit G_upd.

Based on the result of the above-described loss evaluation, the discrimination data evaluation unit D_Ev also generates parameter update data GAN_update(θ_{d}) that is data for updating the parameters θ_{d} of learnable function unit(s) (learnable convolutional layers or the like) of the audio data discrimination device Dev_D, and then transmits the parameter update data GAN_update(θ_{d}) to the audio data discrimination device Dev_D.

### 1.1.6: Update Data Selection Processing Unit G_Upd

The update data selection processing unit G_upd receives the parameter update data pre_update(θ_{g}) transmitted from the generated data evaluation unit G_Ev and the parameter update data GAN_update(θ_{g}) transmitted from the discrimination data evaluation unit D_Ev.

During pre-training, the update data selection processing unit G_upd selects the parameter update data pre_update(θ_{g}), and then transmits the parameter update data pre_update(θ_{g}) as the parameter update data update(θ_{g_cnv}) to the convolution processing unit 3 of the audio data generation device 100.

Further, during learning (adversarial learning), the update data selection processing unit G_upd selects the parameter update data GAN_update(θ_{g}), and then transmits the parameter update data GAN_update(θ_{g}) as the parameter update data update(θ_{g_cnv}) to the convolution processing unit 3 of the audio data generation device 100.

### 1.2: Operation of Audio Data Processing System

The operation of the audio data processing system 1000 configured as above will be explained below. Below, the operation of the audio data processing system 1000 will be explained separately into (1) learning processing and (2) inference processing (prediction processing).

### 1.2.1: Learning Processing

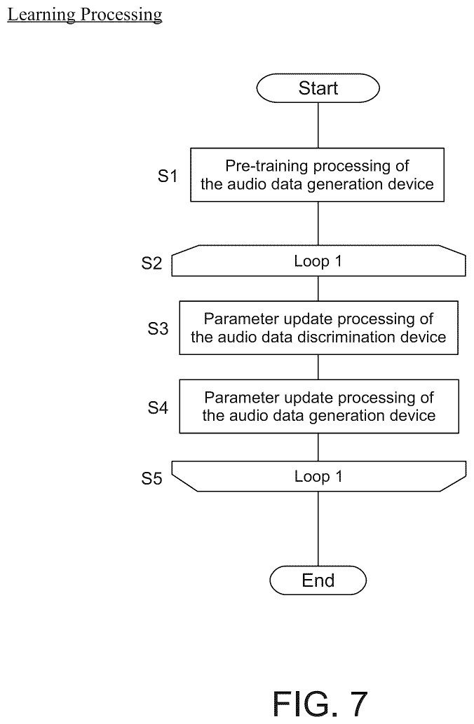

FIG. 7 is a flowchart of the learning processing performed by the audio data processing system 1000.

The learning processing performed by the audio data processing system 1000 will be described below with reference to the flowchart.

### Step S1:

In step S1, pre-training processing of the audio data generation device 100 is performed. Specifically, the following processing is performed.

Data Din, which is mel spectrogram data, is inputted into the first convolution processing unit 11 of the multi-stream generation unit 1.

The first convolution processing unit 11 then performs one-dimensional convolution processing (Conv1D processing) on the data Din (data Din (one-dimensional convolution processing with mel spectrum data considered as two-dimensional data)), and transmits the data after the one-dimensional convolution processing (Conv1D processing) to the MRF unit as data D11. Note that the one-dimensional convolution processing (Conv1D processing) performed by the first convolution processing unit 11 is performed with the kernel size set to “7” (equivalent to 7 samples) and the number of channels set to “512”, for example.

The first up-sampling unit 121 receives the data D11 transmitted from the first convolution processing unit 11, and performs up-sampling processing on the data D11. The first up-sampling unit 121 transmits the data after the up-sampling processing to the first MRF processing unit 122 as data D12. Note that the up-sampling processing performed by the first up-sampling unit 121 is performed, for example, by increasing the number of samples of input data by eight times (×8) and by setting the number of channels to “256”. As a method of up-sampling processing, for example, up-sampling processing using subpixel convolution processing is employed. In other words, the first up-sampling unit 121 performs one-dimensional convolution processing (Conv1D processing) with the kernel size of “3”, for example, and then performs reshaping processing to achieve up-sampling processing. Note that the number of channels for one-dimensional convolution processing (Conv1D processing) and the length for reshaping processing may be adjusted so that the number of samples of input data is increased by eight times (×8) and the number of channels becomes “256”.

The data D12 obtained by the processing in the first up-sampling unit 121 is transmitted to the first MRF processing unit 122.

The first MRF processing unit 122 performs MRF processing on the data D12. Specifically, the following processing is performed.

The data D12 is inputted into the residual block ResBlock[n] (1≤n≤|kᵣ|) of the residual block group 1221 (|kᵣ|represents the number of elements (the number of arrays) of the array kᵣ) (the block configured as shown in FIG. 4); the activation processing with the activation processing unit BL21 by using the Leaky ReLU function and the convolution processing with the block BL22 using the kᵣ[n]×1 kernel are performed in the block BL2 multiple times (|Dr[n, m]| times), and the data after the processing is added to the data D12 in the adder Add1 (processing of block BL1).

The processing of the block BL described above is performed multiple times (|Dr[n]| times). The data after the processing is then transmitted to the addition unit 1222 as data D12_out[n].

The addition unit 1222 adds the output data D12_out[1] to D12_out[|kᵣ|] from each block of the residual block group 1221, and transmits the addition result data to the second up-sampling unit 123 as data D13.

In this way, the first MRF processing unit 122 performs convolution processing using residual blocks with kernels corresponding to various receptive fields, and the data resulting from the processing is integrated in the addition unit 1222; thus, the D13 outputted from 1222 is obtained as data including features extracted using kernels corresponding to various receptive fields.

The data D13 obtained through the processing in the first MRF processing unit 122 is transmitted to the second up-sampling unit 123.

The second up-sampling unit 123 performs up-sampling processing on the data D13 transmitted from the first MRF processing unit 122. The up-sampling processing performed by the second up-sampling unit 123 is performed, for example, by increasing the number of samples of input data by eight times (×8) and by setting the number of channels to “128”. As a method of up-sampling processing, for example, up-sampling processing using subpixel convolution processing is employed, similarly to the first up-sampling unit.

The data D14 obtained by the processing in the second up-sampling unit 123 is transmitted to the second MRF processing unit 124.

The second MRF processing unit 124 has the same configuration as the first MRF processing unit, and performs processing on the data D14 transmitted from the second up-sampling unit 123 in the same manner as the first MRF processing unit (note that the set values of kᵣ and Dr may be different from the set values of the first MRF processing unit). The second MRF processing unit 124 then transmits the data after processing by the second MRF processing unit 124 to the first activation processing unit 13 as data D15.

The first activation processing unit 13 performs activation processing using a Leaky ReLU function on the data D15 transmitted from the second MRF processing unit 124 of the MRF unit 12. The first activation processing unit 13 then transmits the data after the activation processing to the second convolution processing unit 14 as data D16.

The second convolution processing unit 14 performs one-dimensional convolution processing (Conv1D processing) on the data D16 transmitted from the first activation processing unit 13. The second convolution processing unit 14 then transmits the data after the one-dimensional convolution processing (Conv1D processing) to the second activation processing unit 15 as data D17. Note that the one-dimensional convolution processing (Conv1D processing) performed by the second convolution processing unit 14 is performed with the kernel size set to “7” (equivalent to 7 samples) and the number of channels set to “4”, for example.

The second activation processing unit 15 performs activation processing using the tan h function on the data D17 transmitted from the second convolution processing unit 14. The second activation processing unit 15 then transmits the data after the activation processing to the up-sampling unit 2 as data D1. Note that when the number of channels of the second convolution processing unit 14 is “4”, the data D1 is audio waveform data (four pieces of audio waveform data), that is, multi-stream data (a plurality of audio waveform data) obtained by performing the activation processing on each of the four pieces of audio waveform data by the second activation processing unit 15.

The data D1 obtained through the processing in the second activation processing unit 15 is transmitted from the multi-stream generation unit 1 to the up-sampling unit 2.

The up-sampling unit 2 performs, for example, zero insertion type up-sampling processing on the data D1 (multi-stream data (a plurality of audio waveform data)) transmitted from the second activation processing unit 15 of the multi-stream generation unit 1. In the up-sampling processing, the data after the up-sampling processing is outputted to the convolution processing unit 3 as data D2 (multi-stream data (multiple audio waveform data) after the up-sampling processing).

The convolution processing unit 3 performs one-dimensional convolution processing (Conv1D processing (without bias)) on the data D2 transmitted from the up-sampling unit 2. The convolution processing unit 3 then transmits the data after the one-dimensional convolution processing (Conv1D processing) to the generated data evaluation unit and the selector SEL1 as data Dout.

Note that the one-dimensional convolution processing (Conv1D processing (without bias)) performed by the convolution processing unit 3 is performed with the kernel size set to “63” (equivalent to 63 samples) and the number of channels set to “1”, for example. In other words, the data D2 (multi-stream data (for example, four pieces of audio waveform data)) inputted into the convolution processing unit 3 is synthesized by one-dimensional convolution processing (Conv1D processing (without bias)) by the convolution processing unit 3, thereby obtaining (generating) one piece of audio waveform data.

The data Dout obtained by the audio data generation device 100 by performing the above processing is transmitted to the generated data evaluation unit G_Ev.

The generated data evaluation unit G_Ev receives the data Dout transmitted from the audio data generation device 100 and the audio waveform data D_correct (correct data) corresponding to the input data Din (mel spectrogram data) of the audio data generation device 100 used to generate the data Dout. Using an evaluation function (loss function) that evaluates STFT loss (STFT: short-time Fourier transform) for the data Dout and the data D_correct (correct data), the generated data evaluation unit G_Ev evaluates the error (loss) between the two.

Specifically, the generated data evaluation unit G_Ev uses the following STFT loss function to evaluate the loss.

Loss functions L_{sc} and L_{mg} for one STFT acquisition period (a period of applying FFT) are defined as follows.

$${L}_{s c} ( x , {x}_{p r e d} ) = \frac{{\vert \vert \vert STFT ( x ) \vert - \vert STFT ( {x}_{p r e d} ) \vert \vert \vert}_{F}}{{\vert \vert \vert STFT ( x ) \vert \vert \vert}_{F}} \qquad Formula 1$$

x: real audio waveform data (correct data)
x_pred: generated (predicted) audio waveform data (corresponding to output data Dout from the audio data generation device 100)
   |STFT(·)|: function to obtain STFT amplitudes
∥·∥_{F}: Frobenius norm

$${L}_{m g} ( x , {x}_{p r e d} ) = \frac{1}{N} ‖ log \vert STFT ( x ) \vert - log \vert STFT ( {x}_{p r e d} ) \vert {‖}_{1} \qquad Formula 2$$

x: real audio waveform data (correct data)
x_pred: generated (predicted) audio waveform data (corresponding to output data Dout from the audio data generation device 100)
   |STFT(·)|: function to obtain STFT amplitudes
∥·∥₁: L1 norm
N: the number of elements (the number of elements (the number of samples) from which STFT amplitude data was obtained)

The loss function L_{mr_stft} for the acquisition period of M STFTs (period of applying FFT) of the generator G (corresponding to the audio data generation device 100) is defined as follows.

$${L}_{mr\_stft} ( G ) = {𝔼}_{x , {x}_{pred}} [ \frac{1}{M} {\sum }_{m = 1}^{M} ( {L}_{s c}^{( m )} ( x , {x}_{pred} ) + {L}_{mag}^{( m )} ( x , {x}_{p r e d} ) ] \qquad Formula 3$$

E_{x, xpred}[·]: expected value for x, x_{pred}

Using the data Dout transmitted from the audio data generation device 100 and the audio waveform D_correct corresponding to the input data Din (mel spectrogram data) of the audio data generation device 100 used to generate the data Dout, the generated data evaluation unit G_Ev obtains an STFT evaluation value (STFT loss value) with a loss function L_{mr_stft} (obtains it by performing processing corresponding to the above formula). The generated data evaluation unit G_Ev generates the parameter update data pre_update(θ_{g}), which is data for updating the parameters θ_{g} of the learnable function unit(s) (learnable convolutional layers or the like) of the audio data generation device 100 based on the obtained STFT evaluation value (STFT loss value), and then transmits the parameter update data pre_update(θ_{g}) to the update data selection processing unit G_upd.

The update data selection processing unit G_upd selects the parameter update data pre_update(θ_{g}) during pre-training of the audio data generation device 100, and transmits the parameter update data pre_update(θ_{g}) as the parameter update data update(θ_{g_cnv}) to the convolution processing unit 3 of the audio data generation device 100.

During pre-training, the convolution processing unit 3 receives the data update(θ_{g_cnv}) (parameter update data of the parameters θ_{g_cnv} of the convolutional layers of the convolution processing unit 3) transmitted from the update data selection processing unit G_upd, and performs update processing (parameter update processing to reduce loss) for the parameters θ_{g_cnv} of the convolutional layers of the convolution processing unit 3.

After performing the above update processing, the convolution processing unit 3 also generates parameter update data update(θ_{g_ms}) for updating the parameters of the multi-stream generation unit 1 (the second convolution unit 14, the MRF unit 12, and the first convolution processing unit 11), and then transmits the parameter update data update(θ_{g_ms}) to the multi-stream generation unit 1.

During pre-training, the multi-stream generation unit 1 receives the parameter update data update(θ_{g_ms}) transmitted from the convolution processing unit 3 (data for updating the parameters θ_{g_ms} of the multi-stream generation unit 1 (the second convolution unit 14, the MRF unit 12, and the first convolution processing unit 11)); based on the data update(θ_{g_ms}), the multi-stream generation unit 1 performs update processing (parameter update processing to reduce loss) for the parameters θ_{g_cnv} of the multi-stream generation unit 1 (the second convolution unit 14, the MRF unit 12, the first convolution processing unit 11).

In the audio data processing system 1000, the above processing is repeatedly performed (the above processing is repeatedly performed while changing the input data Din); and it is determined that the pre-training processing has converged when (1) the STFT evaluation value (STFT loss value) obtained by the generated data evaluation unit G_Ev falls within a predetermined range, or (2) it no longer varies by more than a predetermined value.

The parameters when it is determined that the pre-training processing has converged are set in the convolution processing unit 3 and the multi-stream generation unit 1 of the audio data generation device 100.

### Step S2:

In step S2, loop processing (loop 1) (adversarial learning processing by the audio data generation device 100 and the audio data discrimination device Dev_D) is started.

### Step S3:

In step S3, parameter update processing of the audio data discrimination device Dev_D is performed. Specifically, the following processing is performed.

For example, the selector SEL1 selects the data Dout (data generated by the audio data generation device 100 (fake data)) in accordance with a selection signal sell transmitted from a control unit (not shown), and inputs the selected data as data Dd1 into the audio data discrimination device Dev_D.

The first discriminator MSD[1] of the global feature discrimination unit DD1 inputs the data Dd1 as it is into the discrimination unit, as shown in FIG. 5. The discrimination unit of the first discriminator MSD[1] performs using the convolutional layer MS1, the down-sampling layer MS2 (for example, a configuration in which four down-sampling layers are connected in series), the convolutional layer MS3, and the conventional layer MS4 on the data Dd1, and then transmits resultant data DD1_MSD_out[1] indicating the authenticity of the input data Dd1 (indicating whether the data Dd1 is real data (Real) or fake data generated by audio generation processing (Fake))) to the discrimination data evaluation unit D_Ev.

The same process as above is performed for discriminators other than the first discriminator MSD[1] of the global feature discrimination unit DD1, and resultant data DD1_MSD_out[k] indicating the authenticity of the input data Dd1 (indicating whether the data Dd1 is real data or fake data generated by audio generation processing (Fake)) is transmitted to the discrimination data evaluation unit D_Ev.

Further, as shown in FIG. 5, the k-th discriminator MPD[k] (k is a natural number satisfying 1≤k≤M) of the detailed feature discrimination unit DD2 inputs the data Dd1 into the reshaping unit of the k-th discriminator MPD[k].

The reshaping unit of the k-th discriminator MPD[k] converts the data Dd1 (one-dimensional data) into two-dimensional data for each periods p[k] (every p[k] samples) (p[k]×ceil(T/p[k]) two-dimensional data (ceil( ) is a ceiling function) where the number of samples of the data Dd1 is T). For example, if p[k]=3 and T=300 is satisfied, the reshaping unit of the k-th discriminator MPD[k] converts the data Dd1 (one-dimensional data) into 3×100 two-dimensional data.

The reshaping unit of the k-th discriminator MPD[k] then transmits the two-dimensional data after the processing to the discrimination unit of the k-th discriminator MPD[k].

The discrimination unit of the k-th discriminator MPD[k] performs convolution processing on the two-dimensional data transmitted from the reshaping unit to obtain resultant data DD2_MPD_out[k] indicating the authenticity of the input data Dd1 (indicating whether the data is real (Real) or fake data generated by audio generation processing (Fake)).

The result data DD2_MPD_out[1] to DD2_MPD_out[M] obtained by the plurality of discriminators MPD[1] to MPD[M] of the detailed feature discrimination unit DD2 are transmitted to the discrimination data evaluation unit D_Ev.

The discrimination data evaluation unit D_Ev inputs the data Dd1_out (DD1_MSD_out[1] to DD1_MSD_out[3]) and Dd2_out (DD2_MPD_out[1] to DD2_MPD_out[M]) transmitted from the audio data discrimination device Dev_D, and stores and retains the resultant data obtained in each discriminator, including information on whether or not the determination of the authenticity was made correctly.

Next, for example, in accordance with the selection signal sell transmitted from the control unit (not shown), the selector SEL1 selects the audio waveform data D_correct (e.g., the audio waveform data D_correct (correct data (real data)) corresponding to the input data Din (mel spectrogram data) of the audio data generation device 100 used to generate the data Dout), and then inputs the selected data into the audio data discrimination device Dev_D as data Dd1. The audio data discrimination device Dev_D then performs the same processing as above.

Similarly to the above, the discrimination data evaluation unit D_Ev receives the data Dd1_out (DD1_MSD_out[1] to DD1_MSD_out[3]) transmitted from the audio data discrimination device Dev_D and the data Dd2_out (DD2_MPD_out[1] to DD2_MPD_out[M]), and stores and retains the resultant data obtained in each discriminator.

Furthermore, the processing in the audio data discrimination device Dev_D is repeated while changing the data inputted into the audio data discrimination device Dev_D to real data or fake data.

The discrimination data evaluation unit D_Ev obtains the probability that the resultant data obtained in each discriminator is correctly discriminated (probability that real data is determined to be real and fake data is determined to be fake).

Using the obtained probability, the loss of the generator and the loss of the discriminator are evaluated with an adversarial learning loss function for the generator (corresponding to the audio data generation device 100) and an adversarial learning loss function for the discriminator (corresponding to the audio data discrimination device Dev_D); based on the evaluation value obtained by the above evaluation, the parameters of the learnable function unit(s) of the audio data discriminator Dev_D (discriminator) are updated, and further the parameters of the learnable function unit(s) of the audio data generation device 100 are updated.

Here, the adversarial learning loss function for the generator (corresponding to the audio data generating device 100) and the adversarial learning loss function for the discriminator (corresponding to the audio data discriminating device Dev_D) will be described.

The loss function L_{Adv}(D;G) for the discriminator D that performs adversarial learning together with the generator G, and the loss function L_{Adv}(G;D) for the generator G that performs adversarial learning together with the discriminator D are as follows.

$${L}_{A d v} ( D ; G ) = {𝔼}_{( x , s )} [ {( D ( x ) — 1 )}^{2} + {( D ( G ( s ) ) )}^{2} ] \qquad Formula 4$$

$${L}_{A d v} ( G ; D ) = {𝔼}_{s} [ {( D ( G ( s ) ) - 1 )}^{2} ]$$

x: real audio waveform data (correct data)
s: input condition (mel spectrogram of real audio waveform data (correct data))
D(x): probability that input data x is correct data (real data)
G(s): data generated by the generator G (the audio data generation device 100) from the input condition s (mel spectrogram of real audio waveform data (correct data))
Furthermore, the loss function L_{Mel}(G) for the mel spectrogram of the generator G is defined as follows.

$${L}_{Mel} ( G ) = {𝔼}_{( x , s )} [ {‖ ϕ ( x ) — ϕ ( G ( s ) ) ‖}_{1} ] \qquad Formula 5$$

φ(˜): function to obtain mel spectrogram corresponding to audio waveform data from the audio waveform data.

Furthermore, a loss function L_{FM}(G;D) for the feature data (feature map) of the generator G that performs adversarial learning together with the discriminator D is defined as follows.

$${L}_{F M} ( G ; D ) = {𝔼}_{( x , s )} [ {\sum }_{i = 1}^{T} \frac{1}{{N}_{i}} ‖ {D}^{i} ( x ) - {D}^{i} ( G ( s ) ) {‖}_{1} ] \qquad Formula 6$$

T: the number of layers of discriminator
Dⁱ: feature data (feature map) of the i-th layer of the discriminator
Nⁱ: the number of feature data (feature maps) of the i-th layer of the discriminator

The loss function LG of adversarial learning of the generator (corresponding to the audio data generation device 100) in a case where K discriminators are provided is defined as follows.

$${L}_{G} = {\sum }_{k = 1}^{K} [ {L}_{Adv} ( G ; {D}_{k} ) + {λ}_{f m} {L}_{FM} ( G ; {D}_{k} ) ] + {λ}_{mel} {L}_{Mel} ( G ) \qquad Formula 7$$

λ_{fm}: coefficient
λₘₑₗ: coefficient
Dₖ: k-th discriminator
K: the number of discriminators

Furthermore, the loss function L_{D} of adversarial learning for a discriminator having K discriminators (corresponding to the audio data discrimination device Dev_D) is defined as follows.

$${L}_{D} = {{\sum }^{K}}_{k = 1} {L}_{Adv} ( {D}_{k} ; G ) \qquad Formula 8$$

Note that in the case of the present embodiment, the first to third discriminators D₁ to D₃ correspond to MSD[1] to MSD[3], and the fourth to 4+M−1st discriminators D₄ to D_{4+M-1} correspond to MPD[1] to MPD[M](K=M+3).

The discrimination data evaluation unit D_Ev obtains the probability that the resultant data from each discriminator is correctly discriminated (probability that real data is determined to be real and fake data is determined to be fake), and performs processing corresponding to the above evaluation function, thereby obtaining the loss function L_{G} for adversarial learning of the audio data generation device 100 (generator) and the loss function L_{D} for adversarial learning of the audio data discrimination device Dev_D (discriminator).

Based on the result of the loss evaluation (loss function L_{D}), the discrimination data evaluation unit D_Ev generates the parameter update data GAN_update(θ_{d}) that is data for updating the parameter θ_{d} of the learnable function unit(s) (learnable convolutional layers or the like) of the audio data discrimination device Dev_D, and then transmits the parameter update data GAN_update(θ_{d}) to the audio data discrimination device Dev_D

During learning (adversarial learning), the audio data discrimination device Dev_D receives the data GAN_update(θd) transmitted from the discrimination data evaluation unit D_Ev (the parameter update data for parameters θ_{d} of the learnable unit(s) (convolutional layers or the like) of the audio data discrimination device Dev_D), and performs updating processing (parameter update processing to reduce loss) for the parameters θ_{g_d} of the learnable unit(s) (convolutional layer or the like) of the audio data discrimination device Dev_D based on the data update(θ_{d}).

### Step S4:

In step S4, parameter update processing of the audio data generation device 100 is performed. Specifically, the following processing is performed.

Similarly to step S3, while changing the data inputted into the audio data discrimination device Dev_D to real data (the data D_correct) or fake data (the data Dout generated by the audio data generation device 100) using the selector SEL1, processing that the audio data discrimination device Dev_D performs in the step S3 (the same process as step S3) is repeated.

Similarly to step S3, the discrimination data evaluation unit D_Ev obtains the probability that the resultant data from each discriminator is correctly discriminated (the probability that real data is determined to be real and fake data is determined to be fake).

Using the obtained probability, the loss of the generator and the loss of the discriminator are evaluated with an adversarial learning loss function for the generator (corresponding to the audio data generation device 100) and an adversarial learning loss function for the discriminator (corresponding to the audio data discrimination device Dev_D); based on the evaluation value obtained by the above evaluation, the parameters of the learnable function unit(s) of the audio data generation device 100 are updated.

Specifically, the discrimination data evaluation unit D_Ev generates parameter update data GAN_update(θ_{g}), which is data for updating the parameters θ_{g} of the learnable function unit(s) (learnable convolutional layers or the like) of the audio data generation device 100 so that the loss obtained by the loss function L_{G} for the adversarial learning of the generator (corresponding to the audio data generator 100) having K discriminators becomes smaller, and then transmits the parameter update data GAN_update(θ_{g}) to the update data selection processing unit G_upd.

The update data selection processing unit G_upd selects the parameter update data GAN_update(θ_{g}) during learning (adversarial learning) of the audio data generation device 100, and then transmits the parameter update data GAN_update(θ_{g}) as the parameter update data update(θ_{g_cnv}) to the convolution processing unit 3 of the audio data generation device 100.

During learning (adversarial learning), the convolution processing unit 3 receives the data update(θ_{g_cnv}) (parameter update data of the parameters θ_{g_cnv} for the convolutional layers of the convolution processing unit 3) transmitted from the update data selection processing unit G_upd; based on the data update(θ_{g_cnv}), the convolution processing unit 3 performs update processing of the parameters θ_{g_cnv} for the convolutional layers of the convolution processing unit 3 (parameter update processing to reduce loss).

After performing the above update processing, the convolution processing unit 3 also generates parameter update data update(θ_{g_ms}) for updating the parameters of the multi-stream generation unit 1 (the second convolution unit 14, the MRF unit 12, and the first convolution processing unit 11), and then transmits the parameter update data update(θ_{g_ms}) to the multi-stream generation unit 1.

During learning (during adversarial learning), the multi-stream generation unit 1 receives the parameter update data update(θ_{g_ms}) transmitted from the convolution processing unit 3 (parameter update data for the parameters θ_{g_ms} of the multi-stream generation unit 1 (the second convolution unit 14, the MRF unit 12, and the first convolution processing unit 11)); based on the data update(θ_{g_ms}), the multi-stream generation unit 1 performs processing (parameter update processing to reduce loss) for updating the parameter θ_{g_cnv} of the multi-stream generation unit 1 (the second convolution unit 14, the MRF unit 12, and the first convolution processing unit 11).

### Step S5:

In step S5, it is determined whether the termination condition of the loop process (loop 1) is satisfied; if it is determined that the termination conditions are not satisfied, the processes of steps S2 to S4 are repeated.

Conversely, if it is determined that the termination condition for the loop process (loop 1) is satisfied, the learning processing is terminated. Note that cases where it is determined that the termination condition of the loop process (loop 1) is satisfied are cases where it can be determined that the adversarial learning has converged; for example, those are the following cases.
(1) A case where the discrimination data evaluation unit D_Ev determines that the value of the loss function L_{G} for adversarial learning of the generator (corresponding to the audio data generation device 100) converges within a predetermined range, and the value of the loss function L_{D} for adversarial learning of discriminator (corresponding to the audio waveform data discrimination device Dev_D) converges within a predetermined range.
(2) A case where the discrimination data evaluation unit D_Ev determines that the amount of change in the value of the loss function L_{G} for adversarial learning of the generator (corresponding to the audio data generation device 100) is within a predetermined range, and the amount of change in the value of the loss function L_{D} for adversarial learning of the discriminator (corresponding to the audio waveform discrimination device Dev_D) is within a predetermined range.

If the above termination condition is satisfied, the audio data processing system 1000 terminates the learning processing, determines the parameters that have been set in the audio data generation device 100 (parameters that have been set in the learnable function unit(s)) at the time the learning processing has been terminated as the optimal parameters, and obtains the audio data generation device 100 in which the optimal parameters have been set as the trained audio data generation device 100.

Predetermined mel spectrogram data is inputted as the data Din into the trained audio data generation device 100 (the audio data generation device 100 in which the optimal parameters have been set); performing processing by the trained audio data generation device 100 allows for obtaining the audio waveform data Dout corresponding to the input mel spectrogram.

The trained audio data generation device 100 is capable of extremely high-speed audio data generation processing, and can generate extremely high-accurate audio data (audio waveform data).

In the trained audio data generation device 100, the multi-stream generation unit 1 obtains a plurality of stream data (multi-stream data, for example, four pieces of data-driven decomposition data (audio waveform data)) as the data D1, and the obtained data D1 is subjected to zero-insertion type up-sampling processing by the up-sampling unit 2, and furthermore convolution processing (Conv1D processing without bias) is performed on the up-sampled data (for example, four pieces of up-sampled data-driven decomposition data (audio waveform data)) by the convolution processing unit 3. In other words, the trained audio data generation device 100 obtains multiple stream data (multi-stream data), and thus its configuration can be simplified; furthermore, merely performing simple processes, that is, (1) up-sampling processing (after zero-insertion type up-sampling processing) and (2) convolution processing by the convolution processing unit 3 (processing equivalent to processing for applying FIR filter(s) to multiple stream data and synthesizing them) in the trained audio data generation device 100 allows for generating audio waveform data.

In other words, the trained audio data generation device 100 performs processing with a simple configuration, and thus processing can be performed with a CPU without using a GPU that is capable of high-speed processing.

Furthermore, the trained audio data generation device 100, which includes the global feature discrimination unit DD1 that discriminates global features, and a detailed feature discrimination unit DD2 that discriminates detailed features, obtains the optimal parameters through adversarial learning using the audio data discrimination device Dev_D having a very strong discrimination ability; this allows the trained audio data generation device 100 to generate extremely highly accurate audio data (audio waveform data).

Note that using audio waveform data (the data Dout) obtained by up-sampling a plurality of stream data obtained by the multi-stream generation unit 1 and then performing convolution processing on the up-sampled data, the audio data generation device 100 performs the adversarial processing with the audio data discrimination device Dev_D; this eliminates the constraint for using sub-band signals as in the conventional technology (Multi-band MelGAN), and thus allows the audio data generation device 100 to efficiently perform the adversarial learning.

As described above, the audio data generation device 100 has a configuration in which the multi-stream generation unit 1 obtains the plurality of pieces of stream data (for example, four pieces of data-driven decomposition data (audio waveform data)); furthermore, introducing the learnable convolution processing unit 3 in the audio data generation device 100 allows for performing adversarial learning with the highly accurate audio data discrimination device Dev_D. Further, the audio data generation device 100 obtained through the adversarial learning can perform high-speed and highly accurate audio data generation processing. Also, the audio data generation device 100 has a simple configuration, and thus allows for performing high-quality audio data generation processing (for example, speech synthesis processing) with high speed without using a GPU that is capable of high-speed processing.

### Other Embodiments

Although the above embodiment describes a case in which the multi-stream generation unit 1 is configured based on the configuration of HiFi-GAN in the audio data generation device 100, the present invention should not be limited to this; for example, the multi-stream generation unit 1 may be configured based on the configuration of Multi-band MelGAN (configuration of up-sampling processing blocks and residual blocks).

Further, in the above embodiment, the loss function shown as the loss function used for adversarial learning is an example; adversarial learning may be performed in the audio data processing system 1000 using other loss functions.

Further, the audio data generation device 100 (trained audio data generation device 100) of the above embodiment is connected to, for example, an audio data processing system that generates a mel spectrogram from text data, and a speech synthesis system (TTS system, TTS: Text-to-Speech) may be implemented.

Each block of the audio data processing system 1000, the audio data generation device 100, and the audio data discrimination device Dev_D described in the above embodiment may be formed using a single chip with a semiconductor device, such as LSI, or some or all of the blocks of the audio data processing system 1000, the audio data generation device 100, and the audio data discrimination device Dev_D may be formed using a single chip.

Note that although the term LSI is used here, it may also be called IC, system LSI, super LSI, or ultra LSI depending on the degree of integration.

The circuit integration technology employed should not be limited to LSI, but the circuit integration may be achieved using a dedicated circuit or a general-purpose processor. A field programmable gate array (FPGA) that can be programmed after the LSI is manufactured, or a reconfigurable processor that can reconfigure connection and setting of circuit cells inside the LSI may be used.

Further, a part or all of the processing of each functional block of each of the above embodiments may be implemented with a program. A part or all of the processing of each functional block of each of the above-described embodiments is then performed by a central processing unit (CPU) in a computer. The programs for these processes may be stored in a storage device, such as a hard disk or a ROM, and may be executed from the ROM or be read into a RAM and then executed.

The processes described in the above embodiment may be implemented by using either hardware or software (including use of an operating system (OS), middleware, or a predetermined library), or may be implemented using both software and hardware.

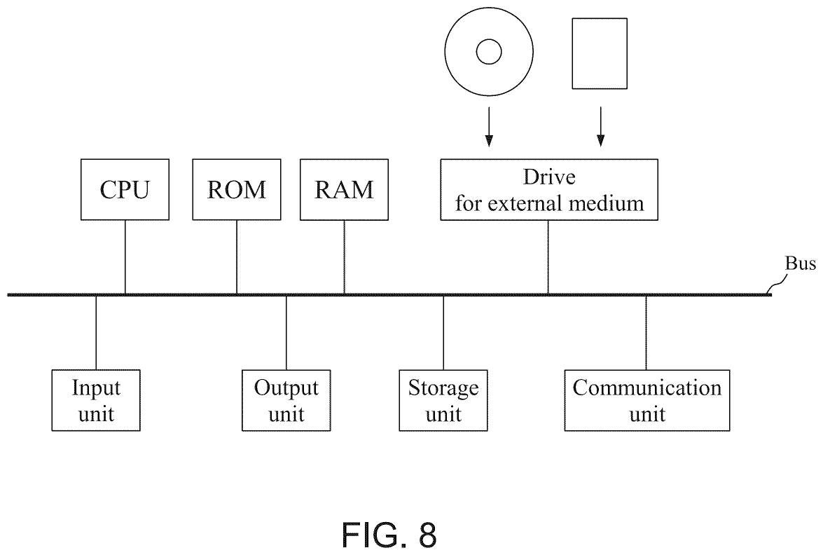

For example, when each function unit of the above embodiment is achieved by using software, the hardware structure (the hardware structure including CPU(s), GPU(s), ROM, RAM, an input unit, an output unit, a communication unit, a storage unit (eg, a storage unit achieved by using HDD, SSD, or the like), a drive for external media or the like, each of which is connected to a bus) shown in FIG. 8 may be employed to achieve the function unit(s) by using software.

When each function unit of the above embodiment is achieved by using software, the software may be achieved by using a single computer having the hardware configuration shown in FIG. 8, and may be achieved by using distributed processes using a plurality of computers.

The processes described in the above embodiment may not be performed in the order specified in the above embodiment. The order in which the processes are performed may be changed without departing from the scope and the spirit of the invention.

The present invention may also include a computer program enabling a computer to implement the method described in the above embodiment and a computer readable recording medium on which such a program is recorded. Examples of the computer readable recording medium include a flexible disk, a hard disk, a CD-ROM, an MO, a DVD, a DVD-ROM, a DVD-RAM, a large capacity DVD, a next-generation DVD, and a semiconductor memory.

The computer program should not be limited to one recorded on the recording medium, but may be transmitted via an electric communication line, a wireless or wired communication line, a network represented by the Internet, or the like.

In addition, in the description in this specification and the description in the scope of claims, “optimization” refers to making the best state, and the parameters for “optimizing” a system (a model) refers to parameters when the value of the objective function for the system is the optimum value. The “optimal value” is the maximum value when the system is in a better state as the value of the objective function for the system increases, whereas it is the minimum value when the system is in a better state as the objective function value for the system decreases. Also, the “optimal value” may be an extremum value. In addition, the “optimal value” may allow a predetermined error (measurement error, quantization error, or the like) and may be a value within a predetermined range (a range for which sufficient convergence for the value can be considered to be achieved).

The specific structures described in the above embodiment are mere examples of the present invention, and may be changed and modified variously without departing from the scope and the spirit of the invention.

### REFERENCE SIGNS LIST

1000 audio data processing system
100 audio data generation device
1 multi-stream generation unit
2 up-sampling unit
3 convolution processing unit
Dev_D audio data discrimination device
D_Ev discrimination data evaluation unit
G_Ev generated data evaluation unit

1: An audio data generation device comprising:
a multi-stream generation unit that includes a learnable function unit and obtains multiple stream data from mel spectrogram data;
an up-sampling unit that obtains up-sampled multi-stream data by performing up-sampling processing on each of the plurality of stream data; and
a convolution processing unit, which is capable of learning parameters for determining convolution processing, that obtains audio waveform data by performing convolution processing on the up-sampled multi-stream data.

2: The audio data generation device according to claim 1, wherein the convolution processing unit performs convolution processing without bias.

3: The audio data generation device according to claim 1, wherein the up-sampling unit performs zero-insertion type up-sampling processing,

4: An adversarial learning method to be performed using the audio data generation device according to claim 1 and an audio data discrimination device including:
a global feature discriminator that includes a learnable function unit and discriminates authenticity of audio data based on global features of audio data; and
a detailed feature discriminator that includes a learnable function unit and discriminates authenticity of audio data based on detailed features of audio data,
the method comprising:
a discrimination step of inputting audio data generated by the audio data generation device or correct data of audio data into the audio data discrimination device, and causing the audio data discrimination device to discriminate authenticity of the input data;
a loss evaluation step of obtaining loss evaluation data using a loss function based on resultant data of the discrimination step;
a generator parameter updating step of updating parameters of the convolution processing unit of the audio data generation device and parameters of the learnable function unit of the multi-stream generation unit based on the loss evaluation data obtained in the loss evaluation step; and
a discriminator parameter updating step of, based on the loss evaluation data obtained in the loss evaluation step, updating the parameters of the learnable function unit of the global feature discriminator of the audio data discrimination, and updating parameters of the learnable function unit of the discriminator of the detailed feature discriminator of the audio data discrimination device.

5: A learning method for the audio data generation device according to claim 1, comprising:
an STFT loss evaluation step of evaluating the loss between audio data corresponding to the mel spectrogram inputted into the audio data generation device and the generated audio data generated from the input mel spectrogram in the audio data generation device using a short-term Fourier transform loss function; and
a generator parameter updating step of updating parameters of the convolution processing unit of the audio data generation device and parameters of the learnable function unit of the multi-stream generation unit based on the evaluation result in the STFT loss evaluation step.

6: A speech synthesis processing system comprising:
an audio processing device that outputs mel spectrum data from text data; and
the audio data generation device according to claim 1.
